(19) United States
(12) Patent Application Publication
(10) Pub. No.: US 2006/0273965 A1
(43) Pub. Date: Dec. 7, 2006

(54) Use of spread spectrum for providing satellite television or other data services to moving vehicles equipped with small size antenna

(75) Inventors: Yoel Gat, Air Port (IL); Raz Shani, Raanana (IL); Danny Spirtus, Holon (IL); Mario Gatchev, Sofia (BG)

Correspondence Address: BANNER & WITCOFF, 1001 G STREET N W, SUITE 1100, WASHINGTON, DC, 20001, US

(73) Assignee: RAYSAT, INC., Vienna, VA (US)

(21) Appl. No.: 11/374,049

(22) Filed: Mar. 14, 2006

Related U.S. Application Data
(63) Continuation-in-part of application No. 11/354,246, filed on Feb. 15, 2006.
Application No. 11/354,246 is a continuation-in-part of application No. 11/324,755, filed on Jan. 4, 2006.
(60) Provisional application No. 60/653,520, filed on Feb. 17, 2005.
(60) Provisional application No. 60/650,122, filed on Feb. 7, 2005.

(51) Int. Cl. H01Q 1/32

(52) U.S. Cl. 343/711

(57) ABSTRACT

Method, system and apparatus for providing dedicated service, using transponders arranged on the geostationary orbit, including satellite television and other data to moving vehicles, equipped with small (less then 30 cm in diameter), low profile antennas, and using signal spreading technique in order to increase the downlink signal strength and to reduce the interference from adjacent satellites ensuring in that way enough margin for the reception by the small size low-profile antennas.

### CROSS REFERENCE TO RELATED APPLICATIONS

The present invention is a continuation-in-part of U.S. application Ser. No. 11/354,246, filed Feb. 15, 2006, which is a continuation-in-part of U.S. application Ser. No. 11/324,755, filed Jan. 4, 2006, entitled System and Method for Low Cost Mobile TV, U.S. application Ser. No. 10/752,088, filed Jan. 7, 2004, entitled Mobile Antenna System for Satellite Communications, U.S. application Ser. No. 11/183,007 filed Jul. 18, 2005, entitled Mobile Antenna System for Satellite Communications, U.S. application Ser. No. 11/074,754, filed Mar. 9, 2005, entitled Method and Apparatus for Providing Low Bit Rate Satellite Television To Moving Vehicles, U.S. application Ser. No. 10/925,937, filed Aug. 26, 2004, entitled System For Concurrent Mobile Two-way Data Communications and TV Reception, U.S. application Ser. No. 11/071,440, filed Mar. 4, 2005, entitled Low Cost Indoor Test Facility and Method for Mobile Satellite Antennas, U.S. application Ser. No. __/______ filed Sep. 6, 2005, entitled Tracking System for Flat Mobile Antenna (PCT/BG2004/000004 filing in U.S. under §371), U.S. application Ser. No. __/______ filed Sep. 6, 2005, entitled Flat Mobile Antenna System (PCT/BG2004/000003 filing in U.S. under §371), U.S. application Ser. No. 10/752,088, filed Jan. 7, 2004, entitled Mobile Antenna System for Satellite Communications, U.S. application Ser. No. 11/183,007, filed Jul. 18, 2005, entitled Mobile Antenna System for Satellite Communications, U.S. application Ser. No. __/______, filed Oct. 25, 2005, entitled Digital Phase Shifter (PCT/BG2004/000008 filing in U.S. under §371), International Application Ser. No. PCT/BG2004/00011, entitled Flat Microwave Antenna, Filed Jul. 7, 2003, U.S. application Ser. No. 10/498,668, Filed Jun. 10, 2004, entitled Antenna Element, U.S. application Ser. No. __/______, (Attorney Docket No. 006681.00070) filed Dec. 30, 2005, entitled Applications for Low Profile Two Way Satellite Antenna System, each of the foregoing applications is hereby specifically incorporated by reference in their entirety herein. With respect to any definitions or defined terms used in the claims herein, to the extent that terms are defined more narrowly in the applications incorporated by reference with respect to how the terms are defined in this application, the definitions in this application shall control.

### BACKGROUND OF THE INVENTION

### Field of Invention

The present invention relates to a method and apparatus for providing satellite television and other data services to moving vehicles using dedicated services through a Ku or Ka band geostationary satellite transponders allowing for a small size, low price, and low complexity antenna terminals.

### SUMMARY OF THE INVENTION

The efficiencies achieved by the aspects of the present invention make it possible to easily integrate the apparatus in a car (or other type of vehicle) roof. The dedicated service may include a method including spreading the spectrum of video and/or data channels so that the full power of the transponder can be made available for a smaller number of carriers with enough power to be received by the small size mobile antennas. The use of spread spectrum may be helpful in order to meet the power spectral density levels, such as in the US for 2 degrees spacing—and also to minimize adjacent satellite interference, such that the spread spectrum “processing gain” will decrease the interfering signals from adjacent satellites.

The present invention provides a method, system and apparatus for providing dedicated service including satellite television and other data to moving vehicles. The satellite service, while available to many kinds of users, is primarily dedicated to mobile users and incorporates a transmission system but could also be used in residential environment with very small antennas, working in Ku and in Ka bands, particularly in systems and methods that incorporate a high degree of digital compression and effective use of satellite modulation, transponder bandwidth and power to permit broadcast quality video to mobile terminals that are smaller and more economical than are now practical. In one of several possible embodiments it is cost-effective to accommodate between 1 and 4 broadcast quality TV channels per transponder. In another preferred embodiment the dedicated service incorporates the mobile terminals equipped with the small size, low profile antennas and receivers, which can process the transmitted signals incorporating a suitable signal processing and despreading blocks as discussed in more detail herein.

In another preferred embodiment of the invention the communication system may provide service for fixed subscribers equipped with very small size antennas.

The communication system, according to one preferred embodiment of the invention, may comprise the feeder hub station, equipped with the transmission system spreading properly the set of uplink channels containing the video or other data information, the dedicated transponder on a geostationary or arranged on another orbit satellite, and a plurality of the mobile subscribers terminals on the ground, using small size low profile antennas.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a method and system for providing television and other data to the moving vehicles according to embodiments of the invention;

FIG. 2 illustrates an exemplary chip synchronization at the transmitter according to the embodiments of the invention;

FIG. 3 illustrates the transmit signal modulator implementation according to the embodiments of the invention;

FIG. 4 illustrates exemplary transmit signal modulator implementations for modulators without a clock output;

FIG. 5 illustrates the block diagram of the receiver in case of a despreader embedded in the receiver DVB chip set according to embodiments of the invention;

FIG. 6 illustrates the block diagram of the despreader/receiver configuration in case where the despreader is arranged as a separate device according to embodiments of the invention;

FIG. 7 illustrates the functional diagram of the despreader according to embodiments of the invention;

FIG. 8 illustrates the functional diagram of the despreader code acquisition implementation according to embodiments of the invention;

FIG. 9 illustrates a diagram of an exemplary satellite acquisition method using a azimuthal (fixed elevation) search cycle;

FIG. 10 illustrates an exemplary satellite acquisition method using elevation (fixed azimuth) search cycle;

FIG. 11 illustrates a block diagram of the terminal's indoor unit comprising antenna controller integrated into the DVB receiver and despreader ASIC;

FIG. 12 Illustrates schematically a system for providing television and other data to the moving vehicles using a standard LNBF as subscriber's mobile antenna according to the embodiment of the invention;

FIG. 13 Illustrates a system for providing television and other data to fixed subscribers using standard LNBF according to embodiments of the invention.

### DETAILED DESCRIPTION OF EMBODIMENTS OF THE INVENTION

The inventions summarized above and in this section include descriptions of the method, system, structure and operations of an apparatus for providing satellite television to moving vehicles.

The transmission system may be variously configured and may incorporate a standard DVB modulator, which may include I/Q inputs and outputs, and a spreader, which also may be variously configured. For example, the spreader may include a system and method to multiply the IQ signals with a properly selected PN sequence. In one exemplary embodiment, the modulation schemes may be QPSK or BPSK, code rate ½ or lower, and using direct sequence spreading, chip rate 30 Mcpc (corresponding to a full transponder bandwidth) with processing gain of 7,15 or 31 and SRRC filter roll-off for example 1.2. The parameters may be variously selected, but in exemplary embodiments of the invention, the spreading method uses chip synchronization where the beginning of the PN sequence will be synchronized to the beginning of each symbol.

The DVB modulator may use DVB-S, DVB-S2 or other suitable standard, but preferably with the processing spreading overlays as described herein.

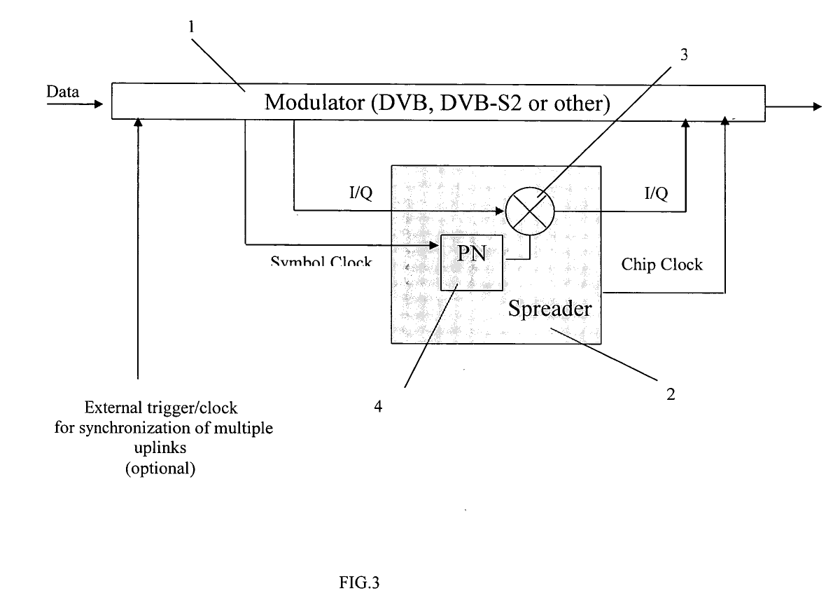

The spreading block may be variously configured to include multipliers and a direct sequence generator. The direct sequence generator may be synchronized using chip and symbol clocks in order to ensure that the beginning of each PN sequence is synchronized with the beginning of each symbol. The chip clock may be generated by the modulator (as in FIG. 3 below) or by the spreader. In another preferred embodiment wherein a modulator with I/Q outputs (analog or digital) is used, the spreader may regenerate the symbol clock and generate the chip clock signal. The spread I/Q signals may be filtered by a SRRC (Squire Root Raised Cosine) filter, which may be situated at the spreader or at the modulator and then delivered to the I/Q modulator and up-converter.

In other possible embodiments, the synchronization between all uplink carriers in the feeder hub station may be done using the external trigger clock. It will allow in the receive side fast switching between channels using one and the same synchronized PN code. In one preferred embodiment when a parallel dispreading in the receiver is used in order to achieve fast PN sequence acquisition, the synchronization between all uplink carriers may not be mandatory.

In one preferred embodiment of the invention the subscribers mobile terminals are equipped with the DVB receivers, which may include a despreader device in order to process the dedicated service spread signals.

The despreader device uses a parallel PN code acquisition process and the PN sequence length as well as the acquisition or hold mode of operation may be controlled by the terminal's signal processor. In another preferred embodiment the receiver status information concerning the PN synchronization availability and E_{S}/N₀ (energy per symbol over noise ratio) value estimation may be supplied to the terminal central processor and used for satellite acquisition and tracking.

In one preferred embodiment of the invention, the despreader may be integrated inside the receiver's DVB chipset, or may alternatively be incorporated directly into the antenna. Where embodiments have the despreader configured as a separate device outside the standard DVB receiver, than any standard type of DVB receivers available on the market may be used in conjunction with the invention.

In one embodiment of the invention, the receiver may include a downconverter, which converts the received signal to base band (zero IF or other), samplers for sampling the complex base-band I/Q signals at a rate equal to twice chip rate, interpolator or other proper device to fix timing and frequency errors, phase/frequency rotator, chip matched SRRC filter with bandwidth for example 30 MHz, despreader and/or a conventional DVB receiver chip set to process the I/Q symbol signals with rate of symbol rate or multiplies of Rs−2*Rs or 4*Rs, delivered from the despreader outputs.

The despreader may be variously configured. In one exemplary embodiment, the despreader comprises two parallel shift register, two multipliers to multiply the signals from the shift registers outputs (odd or even) by a PN (pseudo noise) sequence and a summation/subtraction device. When the despreader is locked, the I/Q symbols at the desired symbol rate may appear at it's outputs. The despreader may, for example, include an absolute output (signal proportional to the module of the I/Q signals), which may be used in the acquisition processed in a separate acquisition block.

The acquisition block may be variously configured to use the absolute I/Q signal, which are demuxed to 62 (twice PN length) hypothesis. Each of the hypothesis may be averaged over many symbols (for example 10,000 symbols). Thereafter, in exemplary embodiments, the strongest hypothesis may be declared, and the clock offset calculated. In case that the strongest hypothesis exceeds the threshold, then the existence of synchronization is declared. The value of the strongest hypothesis may be converted to an estimation of E_{S}/N₀ ratio. The search for the strongest hypothesis may be stop by a hold signal. The averaging process may be done by a fixed window, sliding window, leaky integrator or other proper method. When the despreader is locked the timing tracking is activated and the timing is fixed using a timing loop. In one preferred embodiment of the invention, the timing loop comprises an early/late discriminator & loop filter and an interpolator (or other method for fixing timing errors). The timing loop helps to ensure that in these embodiments, that the timing jitter average is much less then 1 chip.

In the other preferred embodiments, when the despreader is a separate device, the received signal is down-converted to base-band by a tuner (zero IF or other). The complex base band I/Q signal may then be sampled by one or more A/D converters at a rate equal to the twice chip rate and filtered, for example, with SRRC filter (chip matched filter) with bandwidth for example 30 MHz. The I/Q symbols may then be converted to an analog signal, using A/D converter and fed to a standard DVB receiver.

The spreading, acquisition & timing loop is done as described herein. The output signal after the D/A's may be variously configured such as a NRZ type of signal and not a SRRC type of signal expected by a conventional DVB receiver. In this case, it may be desirable to add a SRRC (with BW=Rs) after the despreader (before the D/A's) or by bypassing the SRRC block inside the DVB receiver.

One of the basic issues concerning the system functionality is the satellite acquisition process. In one preferred embodiment of the invention, during the satellite acquisition process the despreader E_{S}/N₀ output signal is read during every average time interval and the minimum value is stored as E_{S}/N₀ₘᵢₙ and, if the current value of E_{S}/N₀ is higher than E_{S}/N₀ₘᵢₙ by a predefined threshold, the antenna holds the current position of the antenna beam and the despreader is allowed to acquire the chip phase precisely and the beam position may be fine tuned.

In one preferred embodiment the satellite search starts from an initial elevation, which may be determined by the information from a GPS receiver or may be identified as the last stored in the CPU controller memory position. The antenna beam may then be shifted through azimuthal angular steps with speed, which could be defined as ratio of antenna beam width to the average despreader code acquisition time. In each one of the angular steps the above described exemplary acquisition procedure is applied. In case that a signal is not acquired for all of the azimuthal angular steps, the beam elevation may be changed by a defined elevation angular step and the process starts from the beginning at this new angular position until the signal from the satellite selected for communication is acquired.

In another preferred embodiment the satellite search starts again from the initial elevation and the beam is shifted in elevation steps with speed defined by the despreader PN code acquisition time and applying the above described satellite acquisition procedure at each elevation angular step. If no satellite signal is acquired then the antenna beam is shifted to the next azimuthal angular step, defined by the azimuthal beamwidth and the process starts from the beginning, checking all elevation steps according to the acquisition procedure above described until the satellite selected for communication is acquired.

In another preferred embodiment of the invention the receive antenna can be a flat array, rotating or static LNBF (Low Noise Block Feed) that consist of antenna feed horn, low noise amplifier and a frequency converter that currently in use as a part of the DTH (Direct To Home) antenna system.

The LNBF may use a modified feed-horn with higher gain - MLNBF (Modified Low Noise Block Feed).

The LNBF or MLNBF may be attached to a rotating platform comprising an azimuth tracking mechanism and mount that tracks the satellite following the car location and direction.

The LNBF or MLNBF may be equipped with a special Azimuth/Elevation or Azimuth/Elevation and polarization mount that will be operational while the user is in a stationary/fixed position.

When the above described satellite acquisition is finished and the satellite selected for communication is locked, then the antenna tracking system may be activated and the satellite tracked while the vehicle is moving and there is a clear line of site to the satellite. In one preferred embodiment of the invention the tracking system comprises a combination of sensors (for example GPS module, electronic compass and gyros), a closed loop signal quality indication system, which may use the information for Es/N0 ratio, provided by the despreading circuit and an antenna beam pointing system controlled by the central processor unit. The antenna beam pointing system may be mechanically, electronically or semi-electronically controlled.

In another preferred embodiment of the invention the antenna controller may be integrated as a part of the combined DVB and despreader ASIC

In another preferred embodiment of the invention two of the DVB, despreader and controller ASICs may be used. The first one may be integrated in the indoor unit inside the vehicle and the second one in the outdoor unit (antenna box) attached or integrated in the car roof as a part of the signal quality indicator circuit, providing information used for satellite acquisition and tracking.

The present invention relates to a satellite TV and data service, provided for example in Ka or Ku bands, aimed for cars including aftermarket & OEM. The invention comprises in exemplary embodiments a small antenna, for example, one of 20-30 cm diameter×2.5 cm high. The antenna is able to support a dedicated cost efficient service, using signal spreading technique, provided by transponders, either kept in geostationary orbit or, if appropriate, on inclined orbit (end of life) DTH satellites. The signal spreading technique may be used in order to increase the effective power of the down-link signal, and at the same time to reduce interferences from adjacent satellites, ensuring in that way enough margin for the reception, using small size low-profile antennas (for example with diameter less then 30 cm) installed in the plurality of mobile subscribers. The lower cost of service provided by the end of life satellites, allows for 1-4 TV channels per transponder still insuring cost effective service having in mind the great number of potential customers. The above approach gives the possibility to reduce dramatically antenna gain of the terminals installed in or on the user's vehicle.

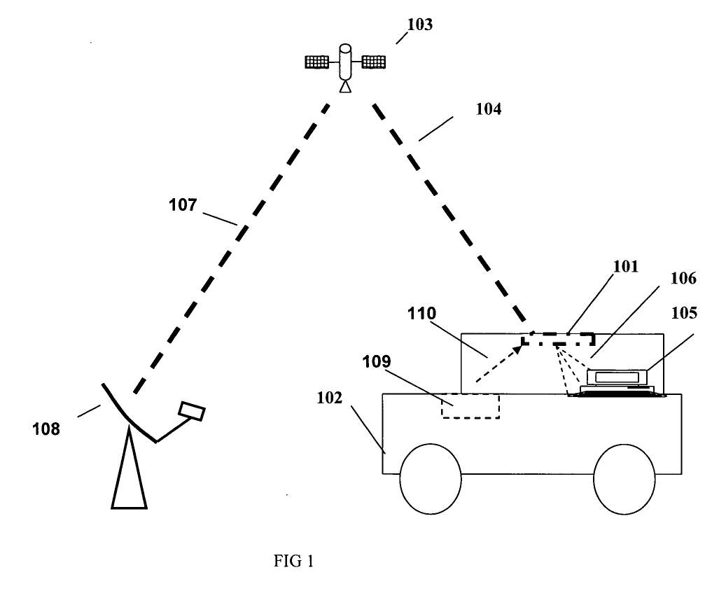

In this manner, small flat antennas with diameter for example 20-30 cm and thickness less than 2.5 cm can be a feasible mass market consumer item that can be mass produced and embedded in the car roof as OEM product. One possible embodiment of the above-described service is shown on FIG. 1. Antenna terminal 101, embedded in the roof of a moving vehicle 102 receive dedicated service signals 104. The dedicated service signals may be received by receivers, which are able to process the dedicated service signals, which may be in one possible embodiment MPEG4 coded or coded using another advanced coding system and processed properly, using signal spreading technique in order to accommodate for example 1-4 channels per transponder. These signals may be variously provided such as by an uplink facility (earth station) 108 using uplink 107 to a satellite. The satellite need not be a fully functional satellite, but could also include an end-of-life (EOL) satellite in an inclined geosynchronous orbit 103. A media device (TV display, audio system, computer, navigation system etc.) 105 may be connected, either wired or wirelessly 106 with the antenna terminal 101. The information needed to control the antenna system beam may be provided by the car navigation system 109. Alternatively, the information may be provided by a sensor system embedded in the antenna terminal 101. In either event, the sensor system and/or navigation system may be coupled to the antenna using a wired or wireless connection 110 to the control and interface circuit, integrated in the antenna terminal 101.

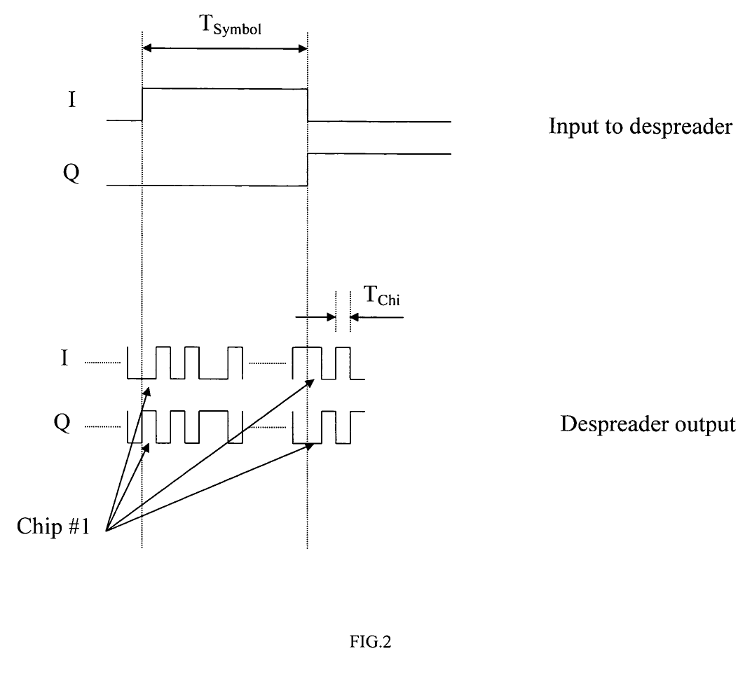

In one preferred embodiment of the invention the dedicated service signal may be set using spreading technique in the transmitter of the hub ground station. The modulator block of the transmitter, according the embodiment of the invention, is shown on FIG. 3. The modulator comprises a DVB-S, DVB-S2 or other standard modulator 1 and a spreader 2. The standard modulator may use QPSK or BPSK modulation scheme with code rate ½ or lower. The spreader 2 may use direct sequence spreading scheme with chip rate of 30 Mcpc, occupying in that way a full transponder bandwidth with processing gain of 7,15 or 31 and SRRC filter roll-off 1.2. In one preferred embodiment of the invention, the spreader may comprise a multiplier 3 and a PN code generator 4 in order to spread I/Q signals. The spreading process may be controlled by chip clock and symbol clock and synchronized in the way that the beginning of the PN sequence is synchronized to the beginning of each symbol. In other possible embodiments, the synchronization between all uplink carriers in the feeder hub station may be done using the external trigger clock. One exemplary synchronization scheme is illustrated on FIG. 2.

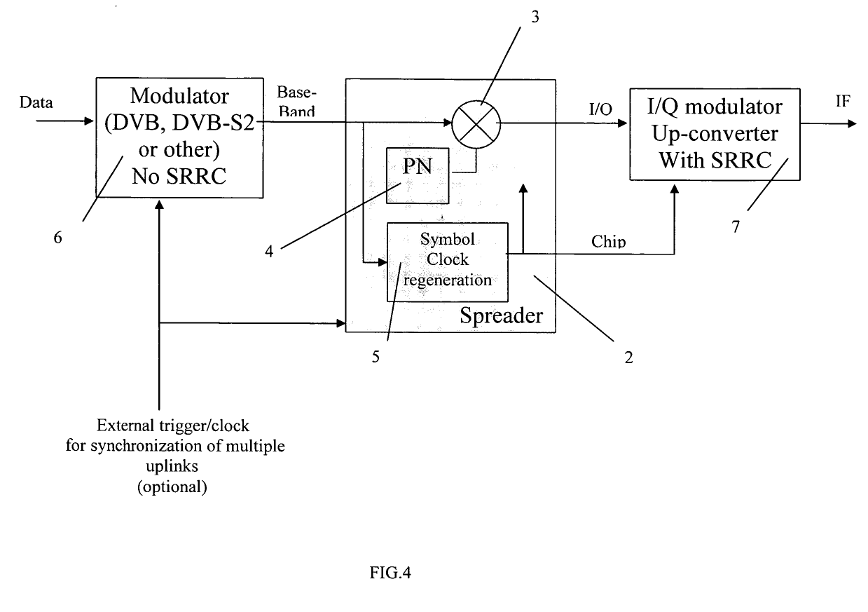

In other possible embodiments, as for example, shown in FIG. 4, a modulator 6 with I/Q outputs (analog or digital) is connected to the spreader 2, which regenerates the Rs (symbol clock) and generate Rc (chip clock), using symbol clock regeneration circuit 5. The spread I/Q signals (analog or digital) may be filtered by a SRRC filter (at the spreader or at the I/Q modulator) and then provided to the I/Q modulator and up-converter 7. In another possible embodiment, the synchronization between all uplink carriers in the feeder hub station may be done using the external trigger clock.

In one preferred embodiment of the invention, the subscribers mobile terminals are equipped with DVB receivers, which comprise a despreader device in order to process the dedicated service spread spectrum signals. The despreader device may use a parallel PN code acquisition process, the PN sequence length, and/or a mode of operation (acquisition or hold) control signals, supplied by, for example, the terminal central processor. From another side the receiver status information, concerning the PN synchronization availability and ES/N₀ (energy per symbol over noise ratio) value estimation may be supplied to the terminal central processor and used for satellite acquisition and tracking.

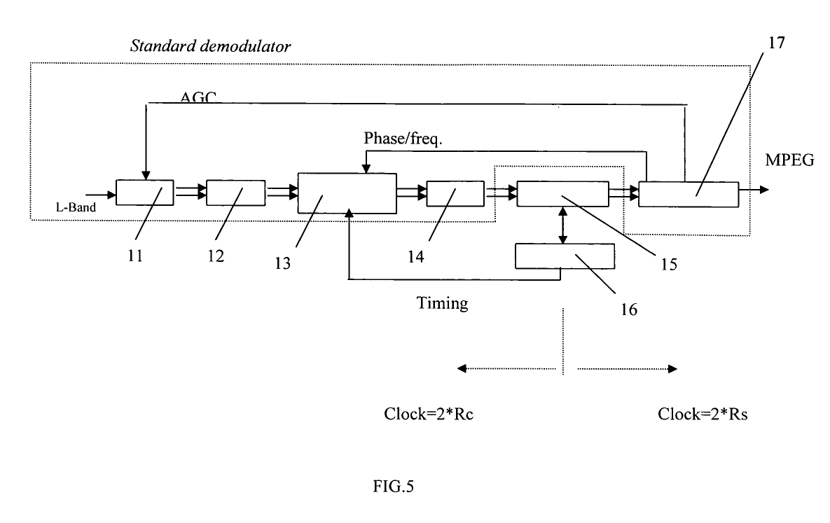

In one preferred embodiment of the invention the despreader may be integrated inside the receiver's chip set and the receiver configuration in that case is illustrated in FIG. 5. The received signal is down-converted to base-band by a tuner (zero IF or other) 11 and then sampled by two separate A/D converters (one for I and one for Q signals) 12 at rate twice higher than the chip rate. The timing and frequency errors may be fixed by an interpolator (or other mean) and phase/frequency rotator respectively 13 and then the signals may be filtered by a SRRC filter (chip matched filter) with bandwidth for example 30 MHz. After that the signal is despread in a despreader 15, it may, for example, be connected to the PN acquisition and tracking circuit 16. When the despreader is locked, the I/Q symbol signals at, for example, the selected symbol rate are transferred to a decoder, which may include phase/frequency and AGC (Automatic Gain Control) loops 17. The timing loop may be done using an early/late timing loop. The loop discriminator and loop filter may be integrated in the despreader 15 and the correction is done by the interpolator 13. The timing loop of the decoder 17 should be disabled.

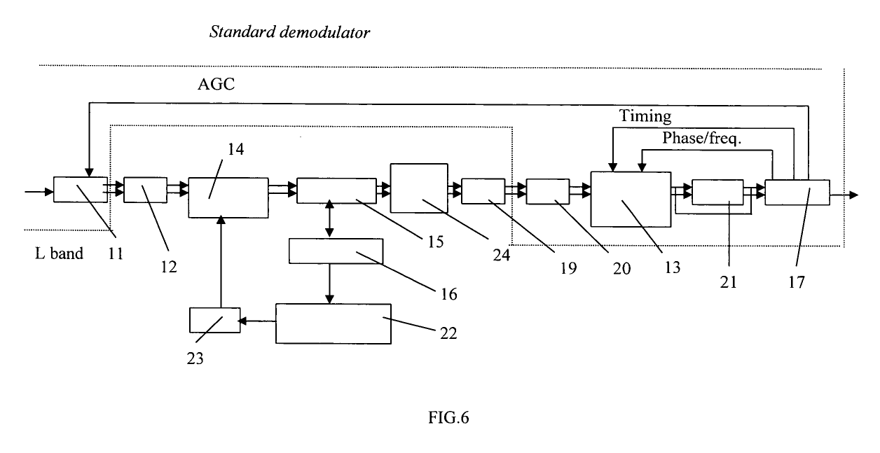

In another preferred embodiment of the invention the despreader may be a separate device connected to a standard DVB receiver. The block diagram of the combination despreader/receiver in that case is illustrated on FIG. 6. The processing is similar to the one described above. The received signal may be down-converted by a tuner 11. The complex base band I/Q signal may then be sampled by two A/D converters 12 at, for example, a rate equal to the twice chip rate and passed through interpolator with SRRC filter 14 (chip matched filter) with bandwidth for example 30 MHz. The I/Q symbols may then be despread by a despreader 15, connected to, for example, the PN acquisition circuit 16. The PN acquisition circuit may be connected to the interpolator 14 through an early/late detector and loop filter circuit 22 and a DDS device 23. The signals from the despreader 15 outputs may be passed through the optional SRRC filter 24 and then converted to digital signals, using D/A converter 19 and fed to a standard DVB receiver. The receiver may include A/D converter 20, interpolator and phase rotator 13 and/or a demodulator chip set 17. The SRRC filtering in this embodiment may be done by a separate SRRC filter 14 and the SRRC filter 21. In this case, the filter embedded in the standard receiver may be bypassed. The timing in case of this embodiment may be performed by DDS device 23 and an early/late detector 22, which lock on the chips. The output signal after the D/As 19 is NRZ signal (and not SRRC signal) but the DVB receiver expects a SRRC signal. The problem may be fixed by adding a SRRC filter (with BW=Rs) 24 after the despreader (before the D/A's) or by bypassing the SRRC block inside the DVB receiver.

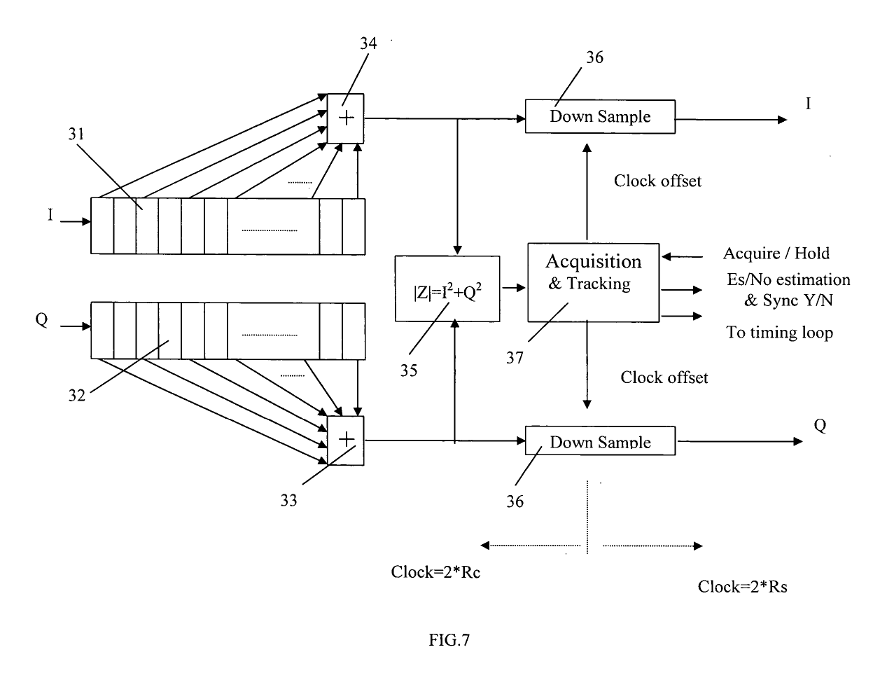

The despreader device, using the parallel acquisition process, is illustrated on FIG. 7. The despreader comprises two parallel shift registers 31 and 32, two multipliers (adders/subtractors) 33 and 34 to multiply the signals from the shift registers outputs (odd or even) by a PN (pseudo noise) sequence and a summation device. The multipliers 33 and 34 may be simple add/subtract devices, since the multiplication is by +1 or −1 sequence. When the despreader is locked, the I/Q symbols at symbol the selected rate appear at it's outputs. The despreader may include an absolute output 35 (signal proportional to the module of the I/Q signals), which may be used in the acquisition processed in a separate acquisition block 37. The acquisition block 37 supplies the clock-offset signals to the two down sample circuits 36 and provides information about signal quality and synchronization availability (locked mode).

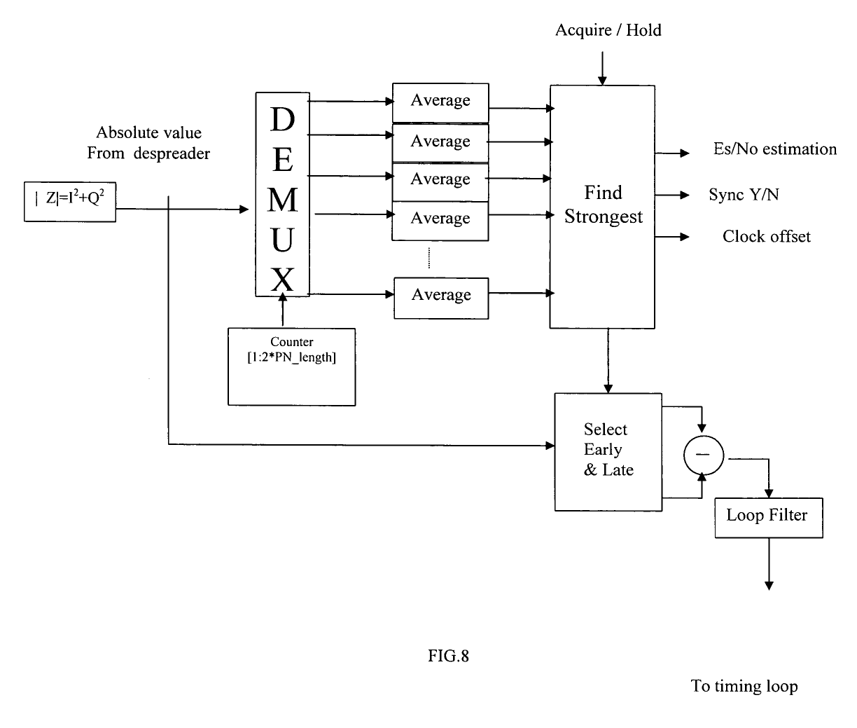

An exemplary acquisition block functional diagram is illustrated on FIG. 8. The acquisition block uses the absolute I/Q signal, delivered by the despreader device, which are demuxed to 62 (twice PN length) hypothesis. Each of the hypothesis may be averaged over many symbols (for example 10 000 symbols) and after that the strongest hypothesis is declared and the clock offset is calculated. In case that the strongest hypothesis exceeds the threshold then the existence of synchronization is declared. The value of the strongest hypothesis may be converted to an estimation of E_{S}/N₀ ratio. The search for the strongest hypothesis may stop by a hold signal. The averaging process may be done by using a fixed window, sliding window, leaky integrator or other proper method. When the despreader is locked the timing tracking is activated. The timing is fixed using a timing loop. The timing loop comprises an early/late discriminator & loop filter and an interpolator (or other method for fixing timing errors). The timing loop may be variously configured to, for example, guaranty that the timing jitter average is much less then 1 chip.

One important problem, concerning the functionality of the communication system according to the embodiment of the invention is the satellite acquisition process. One possible solution is to read the despreader output signal proportional to the current E_{S}/N₀ ratio during every average time interval and the minimum value to be stored as E_{S}/N₀ₘᵢₙ. If the current value of E_{S}/N₀ is found to be higher than E_{S}/N₀ₘᵢₙ by a predefined threshold, then the antenna beam position may be held and the despreader configured to acquire the chip phase precisely and at the same time the beam position is fine tuned.

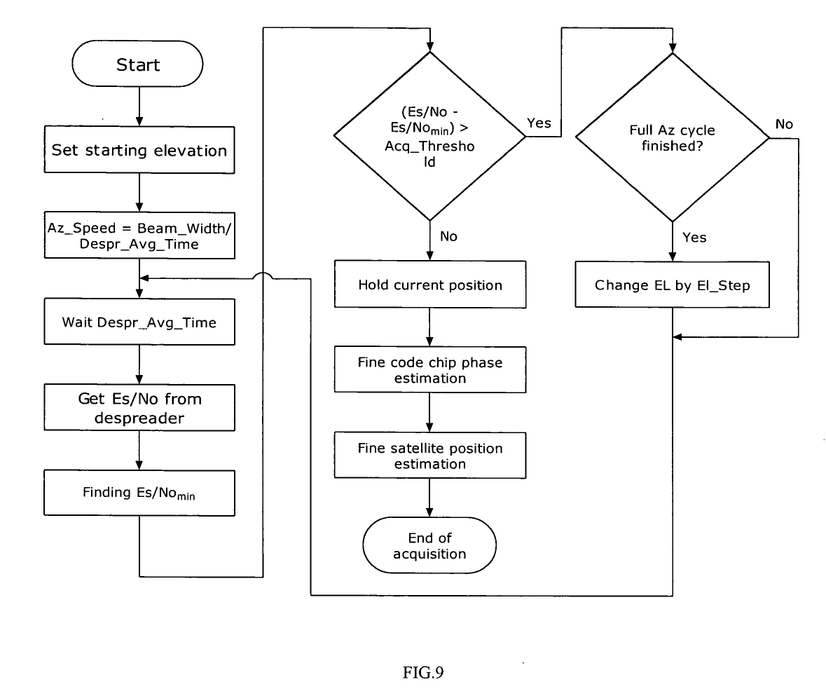

The satellite acquisition flowchart according to one preferred embodiment of the invention is shown on FIG. 9. In this figure, an acquisition method using azimuthal (fixed elevation) search cycle is illustrated. According to this method, the satellite search starts from an initial elevation, which may be determined by the information from a GPS receiver or may be identified as the last value stored in the CPU controller memory position. The antenna beam may then be shifted through azimuthal angular steps with speed, which could be defined as ratio of antenna beam width to the average despreader code acquisition time. In each one of the angular steps the above described acquisition procedure may be variously applied. In case that no signal is acquired for all of the azimuthal angular steps the beam elevation may be changed by a defined elevation angular step and the process starts from the beginning at this new angular position until the signal from the satellite selected for communication is acquired.

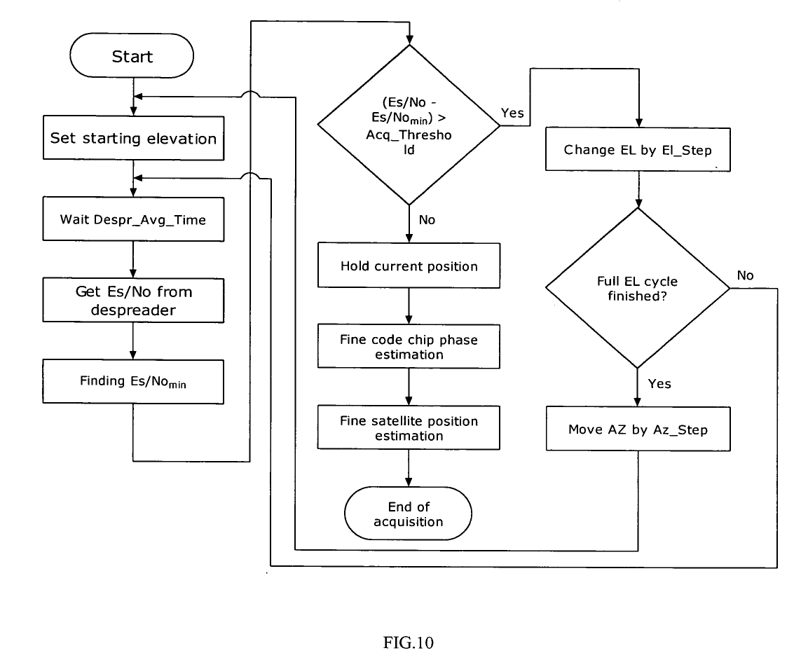

The satellite acquisition flowchart according to another preferred embodiment of the invention is shown on FIG. 10, wherein a satellite acquisition method using elevation (fixed azimuth) search cycle is illustrated. According to this method the satellite search starts again from the initial elevation and the beam is shifted in elevation steps with speed defined by the despreader PN code acquisition time and applying the above described satellite acquisition procedure at each elevation angular step. If no satellite signal is acquired then the antenna beam is shifted to the next azimuthal angular step, defined by the azimuthal beamwidth and the process stars from the beginning checking all elevation steps according to the acquisition procedure above described until the satellite selected fro communication is acquired.

When the above described satellite acquisition is finished and the satellite selected for communication may be locked, then the antenna tracking system may be activated and the satellite is tracked while the vehicle is on the move and there is a clear line of site to the satellite. In one preferred embodiment of the invention the tracking system comprises a combination of sensors (for example GPS module, electronic compass and gyros), a closed loop signal quality indication system, which may use the information for Es/N0 ratio, provided by the despreading circuit and an antenna beam pointing system controlled by the central processor unit. The antenna beam pointing system may be mechanically, electronically or semi electronically controlled.

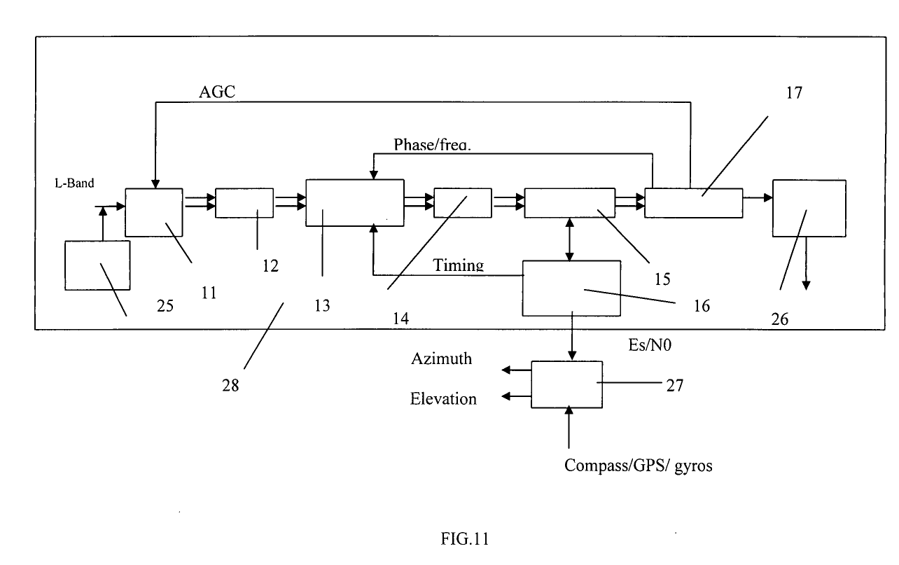

In one preferred embodiment of the invention shown on FIG. 11, the antenna controller 27 may be integrated as a part of the combined DVB and despreader ASIC 28. The antenna controller 27 may receive information about received signal quality from the despreader's acquisition block (estimated value of E_{S}/No), information for the mobile platform rotation from gyro sensors and information for geographical position of the vehicle from GPS and electronic compass devices. The information then may be processed by the terminal central processing unit in order to point antenna beam properly to the satellite selected for communication.

In another preferred embodiment of the invention two of the DVB, despreader and controller ASICs may be used. The first one may be integrated in the indoor unit inside the vehicle and the second one in the outdoor unit (antenna box) attached or integrated in the car roof as a part of the signal quality indicator circuit, providing information used for satellite acquisition and tracking.

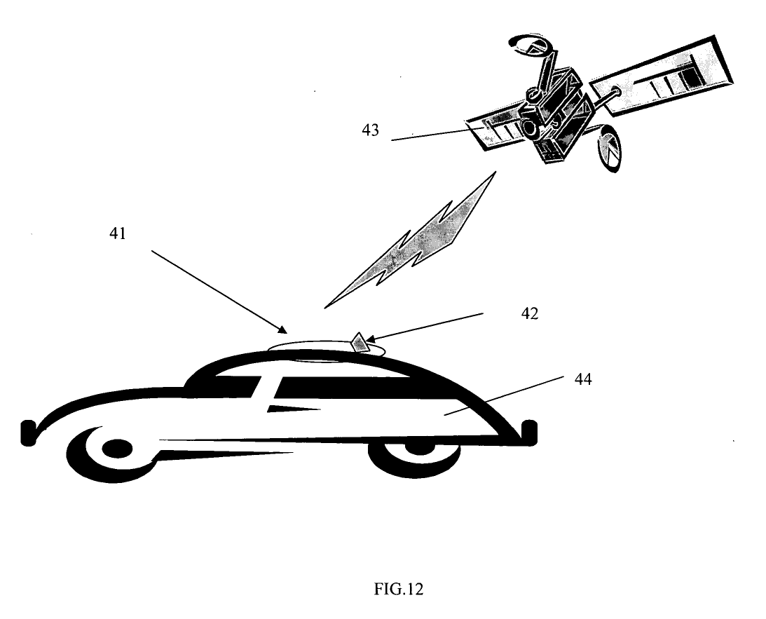

In one exemplary embodiment of the invention, shown on FIG. 12, a standard LNBF (Low Noise Block Feed) 42, similar to those widely used in DTH antenna systems may be used as a subscriber's mobile terminal antenna. The LNBF 42 is arranged on an azimuthally rotating platform with signal control and tracking blocks 41 in order to acquire and track the selected for communication satellite 43 and mounted properly on the vehicle 44. The rotating platform with the LNBF, mounted on it may be arranged in an environmentally resisting box and covered with radio transparent radome.

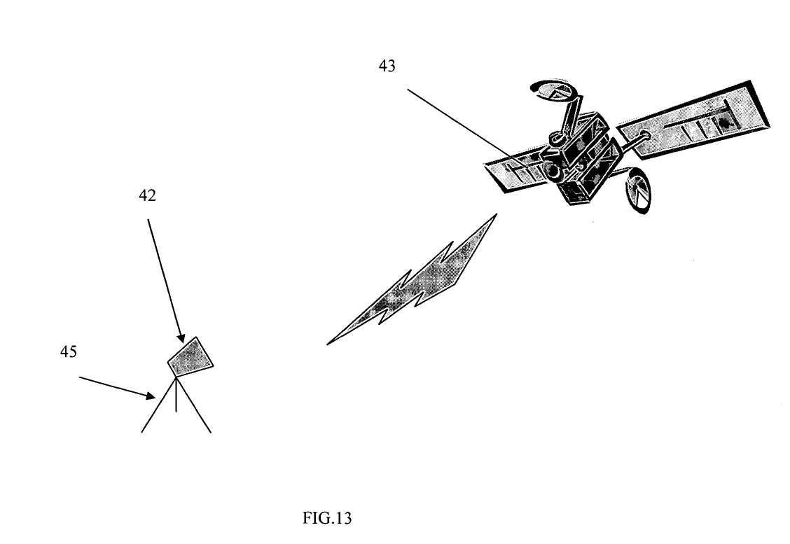

In another embodiment of the invention, shown on FIG. 13 the LNBF antenna 42 may be arranged on a proper azimuth/elevation mount 45 and used as a fixed subscriber's antenna pointed properly, and polarizationally aligned to the satellite selected for communication 43.

What claim is:

1. A method comprising providing a dedicated television service or other data using transponders arranged on the geostationary orbit to plurality of users on the ground equipped with small (less then 30 cm in diameter) low profile antennas and using signal spreading technique in order to increase the downlink signal strength and to reduce the interference from adjacent satellites ensuring in that way enough margin for the reception by the said small size low-profile antennas.

2. The method of claim 1 including delivering the dedicated television service or other data to moving vehicles.

3. The method according claim 1, wherein the signal spreading is done in a ground hub station modulator using direct sequence spreading with chip rate 30 Mcpc, occupying a full transponder bandwidth.

4. Method and system according claim 2, wherein the beginning of the PN sequence will be synchronized to the beginning of each symbol

5. Method and system according claim 2, wherein a modulator with I/Q outputs (analog or digital) is connected to the spreader, which regenerates the Rs (symbol clock) and generate Rc (chip clock), using symbol clock regeneration circuit and thee spreaded I/Q signals (analog or digital) is filtered by a SRRC filter (at the spreader or at the I/Q modulator) and then provided (to the I/Q modulator and up-converter .

6. Method and system according claim 1, wherein the dedicated service spreaded signal is despreaded in the mobile vehicle receivers using parallel PN code acquisition process.

7. Method and system according claim 4, wherein the receiver despreader provides information about the synchronization availability and signal quality (for example for Eₛ/N₀ ratio), which may be used for antenna acquisition and tracking.

8. Method, system and apparatus according claim 1, wherein signal despreader may be integrated inside the DVB chip set of the mobile terminal receiver.

9. Method, system and apparatus according claim 1, wherein signal despreader may be a separate device outside DVB receiver's chip set.

10. System according claim 6, wherein the received by a terminal receiver signal is down-converted to base band by a tuner, the complex base-band (I/Q) signal is sampled by two analog to digital converters at a rate equal to twice chip rate, timing and frequency errors are fixed by an interpolator and phase frequency rotator, the signal is filtered with a chip matched filter with bandwidth of 30 MHz and then despreaded in the despreader, wherein at the despreader's output I/Q symbols are at symbol rate.

11. System according claim 7 wherein the despreader may be a separate device, wherein at its outputs the I/Q symbols are converted to analog signals and feed to a standard DVB receiver.

12. System according claim 9 wherein matched filtering is done by the despreader and the matched filter in the DVB received may be bypassed.

13. System according claim 9 wherein a DDS with early-late loop should lock on the chips.

14. Method and system according claim 4, using despreader, wherein the received spread spectrum signals are fed to two parallel shift registers and the input clock is twice the chip rate.

15. Method and system according claim 12, wherein the shift register's odd (or even) outputs are multiplied by the PN (pseudo noise) sequence and summed.

16. System according claim 13 wherein the multipliers may be simple add/subtract devices.

17. System according claim 12, wherein when the despreader is locked the output signals are I/Q symbols at symbol rate.

18. System according claim 12, wherein the despreader has and absolute output I/Q signals, used for the PN sequence acquisition process.

19. System and method according claim 16, wherein the absolute values I/Q signals output with rate twice the chip rate are demuxed to 62 (twice PN sequence length) hypothesis, each hypothesis is averaged over many symbols (for example 10000), the strongest hypothesis is declared and the clock offset is calculated, if the strongest hypothesis is larger then a threshold the synchronization availability is declared, the value of the strongest hypothesis divided by a neighbor hypothesis (1 chip aside) may be converted to a signal quality estimation and used in the process of satellite acquisition.

20. System and method according claim 18 wherein the two neighbors of the strongest hypothesis, called early and late are subtracted to generate the timing error, filtered to reduce the timing jitter and delivered to the an interpolator (or other method for fixing time errors).

21. System and method according claim 17, wherein the search for the strongest hypothesis may be stooped by a hold signal.

22. The methods and system according claim 17, wherein the averaging may be done by a fixed window, sliding window, leaky integrator or other proper methods.

23. Method, system and apparatus according claim 1, wherein the satellite acquisition process in mobile subscribers terminals may be done by reading the despreader output signal proportional to the current E_{S}/N₀ ratio during every average time interval and storing the minimum value as E_{S}/N₀ₘᵢₙ. If the current value of E_{S}/N₀ is found to be higher than E_{S}/N₀ₘᵢₙ by a predefined threshold, then the antenna beam position is hold and the despreader is let to acquire the chip phase precisely and at the same time to fine tune the beam position.

24. Method according claim 20, wherein the satellite search starts from an initial elevation, which may be determined by the information from a GPS receiver or may de identified as the last stored in the CPU controller memory position. The antenna beam is shifted through azimuthal angular steps with speed, which could be defined as ratio of antenna beam width to the average despreader code acquisition time. In each one of the angular steps the above described acquisition procedure is applied. In case that no signal is acquired for all of the azimuthal angular steps the beam elevation is changed by a defined elevation angular step and the process starts from the beginning at this new angular position until the signal from the satellite selected for communication is acquired.

25. Method according claim 20, wherein the satellite search starts the initial elevation and the beam is shifted in elevation steps with speed defined by the despreader PN code acquisition time and applying the satellite acquisition procedure at each elevation angular step. If no satellite signal is acquired then the antenna beam is shifted to the next azimuthal angular step, defined by the azimuthal beam width and the process stars from the beginning checking all elevation steps according to the acquisition procedure above described until the satellite selected fro communication is acquired.

26. Method and system according claim 5, wherein the antenna controller may be integrated as a part of the combined DVB/despreader ASIC and the antenna controller receiving information about received signal quality from the despreader's acquisition block (estimated value of E_{S}/No), information from the mobile platform rotation from gyro sensors and information for geographical position of the vehicle from GPS and electronic compass devices, to control on move the antenna beam pointing toward the satellite selected for communication.

27. Method and system according claim 25, wherein two of the DVB, despreader and controller ASICs may be used. The first one may be integrated in the indoor unit inside the vehicle and the second one in the outdoor unit (antenna box) attached or integrated in the car roof as a part of the signal quality indicator circuit, providing information used for satellite acquisition and tracking.

28. Method and system according to claim 1, wherein a standard LNBF (Low Noise Block Feed) similar to these used as reflector feed blocks in DTH systems, is used as the small size subscriber's mobile antenna supporting the dedicated service, using spread spectrum signals.

29. Method and system according claim 27 wherein the LNBF or MLNBF is arranged on an azimuthally rotating platform equipped with signal control and tracking blocks in order to acquire and track the satellite selected for communication.

30. Method and system according claim 1 wherein a standard LNBF is used as a fixed subscriber's antenna terminal supporting the dedicated service, using spread spectrum signals.
